(19) United States
(12) Patent Application Publication
(10) Pub. No.: US 2026/0187936 A1
(43) Pub. Date: Jul. 2, 2026

(54) A SYSTEM, A NON-TRANSITORY COMPUTER-READABLE STORAGE MEDIUM, AND METHOD FOR 3D MODELING

(71) Applicant: Sony Group Corporation, Tokyo (JP)

(72) Inventor: Terunari FUJI, Tokyo (JP)

(73) Assignee: Sony Group Corporation, Tokyo (JP)

(21) Appl. No.: 19/130,958

(22) PCT Filed: Dec. 18, 2023
(86) PCT No.: PCT/JP2023/045213

§ 371 Date: May 19, 2025

(30) Foreign Application Priority Data
Jan. 6, 2023 (JP) 2023-000827

(51) Int. Cl. G06T 19/00; G06F 40/279; G06F 40/40; G06T 17/00

(52) U.S. Cl. CPC G06T 19/00; G06F 40/279; G06F 40/40; G06T 17/00

(57) ABSTRACT

A system for performing 3D modeling using text as input includes processing circuitry configured to acquire text indicating a target model, generate a parameter based on the text, and acquire a three-dimensional (3D) model of the target model based on the parameter. The processing circuitry is further configured to extract one or more elements related to the target model from the text and match each of the one or more elements related to the target model with one or more 3D model features.

### TECHNICAL FIELD

The present technology relates to a system, a non-transitory computer-readable storage medium, and a method, and more particularly, to a system, a non-transitory computer-readable storage medium, and a method capable of easily performing 3D modeling.

### CROSS REFERENCE TO RELATED APPLICATIONS

This application claims the benefit of Japanese Priority Patent Application JP 2023-000827 filed on Jan. 6, 2023, the entire contents of which are incorporated herein by reference.

### BACKGROUND ART

3D modeling is generally performed to generate a 3D model of an object having a three-dimensional shape.

For example, there has been a tool that is capable of performing 3D modeling with respect to a human face by adjusting some parameters such as a position of an eyebrow, a distance between an eyebrow and an eye, and a distance between eyebrows. In addition, for example, PTL 1 describes a technology of, when point cloud data or an image indicating a building group is input, estimating a feature parameter of the building group on the basis of the point cloud data or the image, and generating a 3D model of a building group similar to the building group indicated by the point cloud data or the image.

### CITATION LIST

### Patent Literature

PTL 1: Japanese Patent Application Laid-Open No. 2021-189848.

### SUMMARY OF INVENTION

### Technical Problem

Although 3D modeling tools have made 3D modeling less difficult, it is required for users to understand tool operating methods and to become familiar with the operation of the tools in order to create desired 3D models. Furthermore, in the technology described in PTL 1, it is difficult for a user who does not have specialized knowledge to prepare point cloud data as an input.

Under such circumstances, the present technology has been made to enable easy 3D modeling.

### Solution to Problem

A system, comprising: processing circuitry configured to acquire text indicating a target model, generate a parameter based on the text, and acquire a three-dimensional (3D) model of the target model based on the parameter.

A non-transitory computer-readable storage medium storing computer-readable instructions thereon which, when executed by an information processing device, cause the information processing device to perform a method, the method comprising: acquiring text indicating a target model; generating a parameter based on the text; and acquiring a three-dimensional (3D) model of the target model based on the parameter.

A method, comprising: acquiring text indicating a target model; generating a parameter based on the text; and

acquiring a three-dimensional (3D) model of the target model based on the parameter.

### BRIEF DESCRIPTION OF DRAWINGS

FIG. 1 is a diagram illustrating a configuration example of an information processing system according to an embodiment of the present technology.

FIG. 2 is a diagram illustrating an example of a flow of 3D modeling performed by the information processing system according to the present technology.

FIG. 3 is a diagram illustrating an example of a text input screen.

FIG. 4 is a block diagram illustrating functional configuration examples of a user terminal and a server.

FIG. 5 is a flowchart illustrating processes performed by the information processing system.

FIG. 6 is a diagram illustrating examples of feature amounts of a 3D model.

FIG. 7 is a diagram illustrating an example in which each element related to the 3D model in a text is matched with a feature amount of the 3D model.

FIG. 8 is a diagram illustrating an example of a parameter sampled from a parameter distribution.

FIG. 9 is a block diagram illustrating another functional configuration example of the server.

FIG. 10 is a block diagram illustrating a configuration example of hardware of a computer.

### DESCRIPTION OF EMBODIMENTS

Hereinafter, embodiments for carrying out the present technology will be described. The description will be given in the following order.
1. Outline of Information Processing System
2. Configuration and Operation of Each Device
3. Modifications

### 1. Outline of Information Processing System

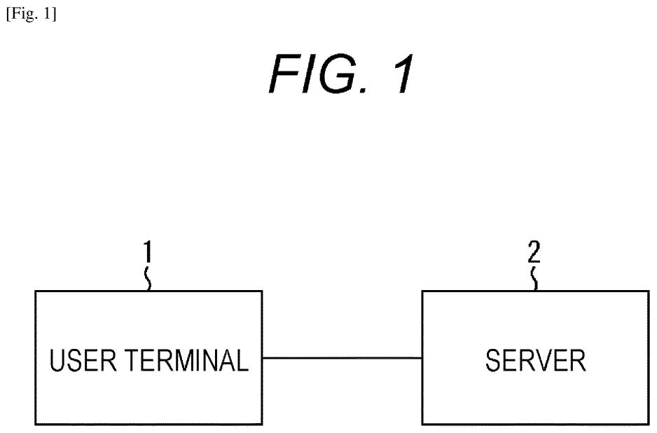

FIG. 1 is a diagram illustrating a configuration example of an information processing system according to an embodiment of the present technology.

The information processing system in FIG. 1 is a system that implements 3D modeling for generating a 3D model of an object having a three-dimensional shape. As illustrated in FIG. 1, the information processing system is configured by connecting a user terminal 1 and a server 2 to each other via wired or wireless communication.

The user terminal 1 includes an information processing device such as a smartphone, a tablet terminal, or a PC. The user terminal 1 receives an input of a text described in a natural language and transmits the input text to the server 2. In addition, the user terminal 1 acquires a 3D model using a parameter generated by the server 2 and displays the 3D model on a display or the like.

The server 2 includes, for example, a web server or a server device (information processing device) on a cloud. The server 2 acquires a text input in the user terminal 1 and generates a parameter to be used for 3D modeling on the basis of the text. The server 2 transmits the generated parameter to the user terminal 1.

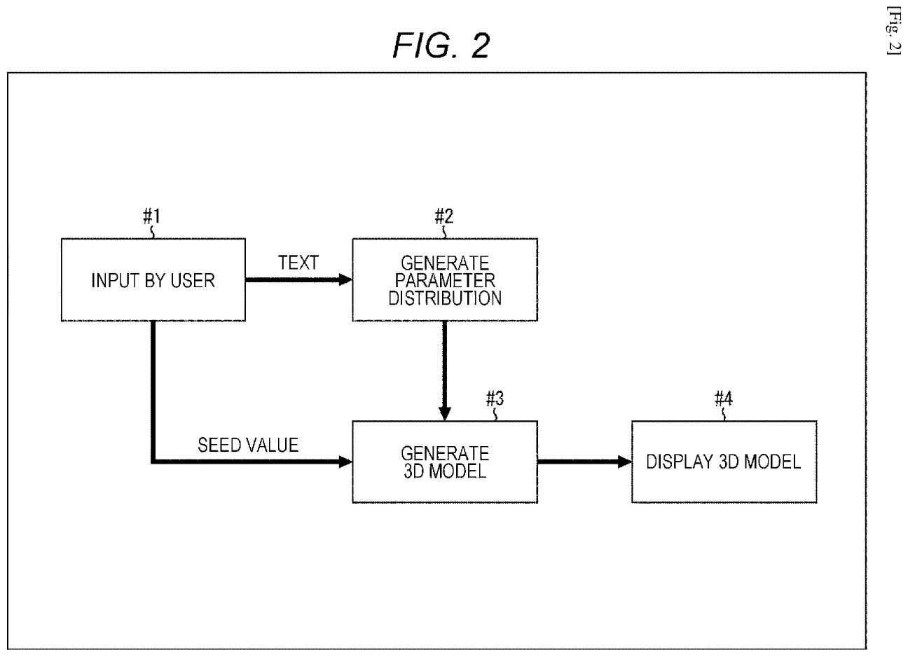

FIG. 2 is a diagram illustrating an example of a flow of 3D modeling performed by the information processing system according to the present technology.

First, the information processing system receives an input of a text by a user as indicated by #1 in FIG. 2. In addition, the information processing system receives an input of a seed value to be used for generating a parameter together with the input of the text. The text and the seed value are input by, for example, the user inputting a character on a text input screen displayed on the display of the user terminal 1 or inputting a voice using a microphone provided in the user terminal 1.

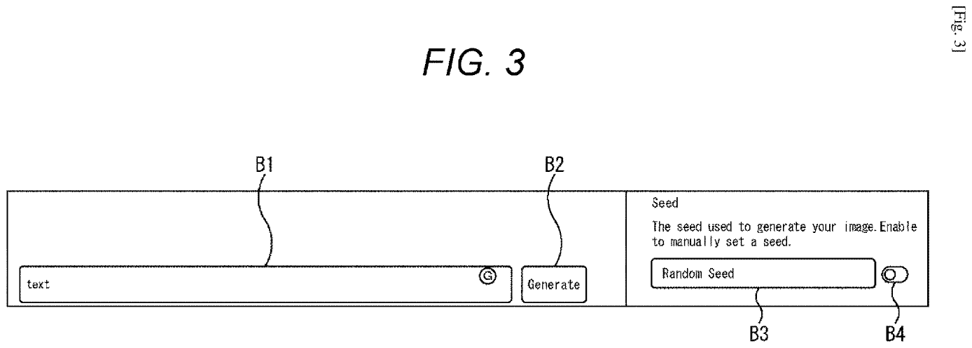

FIG. 3 is a diagram illustrating an example of the text input screen.

As illustrated in FIG. 3, for example, a text box B1 for inputting a text is arranged in a lower left portion of the text input screen. A button B2 for generating a 3D model is arranged on a right side of the text box B1.

A text box B3 for inputting a seed value is arranged on a lower right portion of the text input screen. A toggle button B4 for switching on/off a function of randomly generating a seed value is arranged on a right side of the text box B3.

In a case where the information processing system sets, for example, a townscape as a 3D modeling target, the user inputs a text indicating a state of a desired townscape to the text box B1, and inputs, for example, an integer as a seed value to the text box B3. When the button B2 is pressed after the input of the text and the seed value is completed, a 3D model of a townscape in which the content of the text is reflected is generated, and the 3D model is displayed, for example, on an upper side of the text input screen. Note that the 3D model of the townscape is configured, for example, by combining 3D objects such as buildings, people, cars, and roads.

In a case where the function of randomly generating a seed value is switched on, when the button B2 is pressed in a state where any seed value is not input, for example, the server 2 randomly generates a seed value. The randomly generated seed value is displayed, for example, in the text box B3. Note that the user terminal 1 may randomly generate a seed value.

Returning to FIG. 2, next, the information processing system generates a parameter distribution on the basis of the text input by the user as indicated by #2 in FIG. 2. The parameter distribution includes, for example, a plurality of parameters randomly selected according to a uniform distribution within a range in which the 3D model is a model corresponding to the content of the text.

Next, the information processing system generates a 3D model on the basis of the parameter distribution and the seed value as indicated by #3 in FIG. 2. Specifically, the information processing system samples a parameter among the plurality of parameters included in the parameter distribution, and generates a 3D model using the sampled parameter. The seed value is used to sample the parameter from the parameter distribution.

Note that a 3D model may be acquired by selecting one 3D model from among a plurality of 3D models generated in advance using different parameters, instead of generating a 3D model. In this case, one 3D model generated using a parameter having the same value as the parameter included in the parameter distribution generated in #2 is selected from among the plurality of 3D models.

Lastly, as indicated by #4 in FIG. 2, the information processing system displays the generated 3D model on the display or the like to be presented to the user.

As described above, in the information processing system according to the present technology, a text input by the user and indicating a 3D modeling target is acquired, a parameter based on the text is generated, and a 3D model of the 3D modeling target is acquired using the parameter.

In related art, for example, there has been a tool that is capable of performing 3D modeling with respect to a human face by adjusting some parameters such as a position of an eyebrow, a distance between an eyebrow and an eye, and a distance between eyebrows. In addition, for example, PTL 1 describes a technology of, when point cloud data or an image indicating a building group is input, estimating a feature parameter of the building group on the basis of the point cloud data or the image, and generating a 3D model of a building group similar to the building group indicated by the point cloud data or the image.

Although 3D modeling tools have made 3D modeling less difficult, it is required for users to understand tool operating methods and to become familiar with the operation of the tools in order to create desired 3D models. Furthermore, in the technology described in PTL 1, it is difficult for a user who does not have specialized knowledge to prepare point cloud data as an input.

In the information processing system according to the present technology, since 3D modeling can be performed by inputting a text described in a natural language, even a user who does not have knowledge or skill regarding 3D modeling can easily create a desired 3D model.

### 2. Configuration and Operation of Each Device

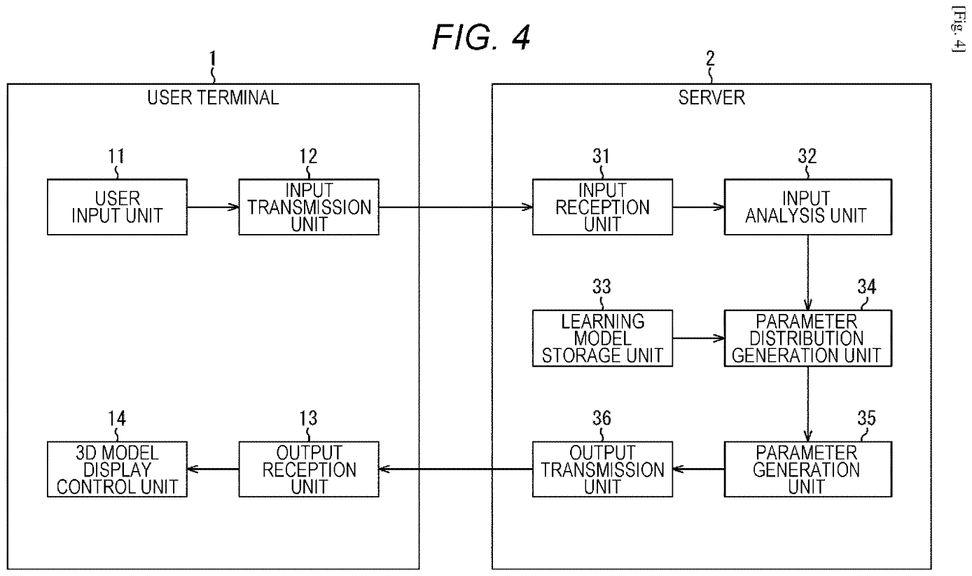

FIG. 4 is a block diagram illustrating functional configuration examples of the user terminal 1 and the server 2.

As illustrated in FIG. 4, the user terminal 1 includes a user input unit 11, an input transmission unit 12, an output reception unit 13, and a 3D model display control unit 14.

The user input unit 11 receives an input of a text and a seed value by the user, and supplies the input text and seed value to the input transmission unit 12. In a case where no seed value is input by the user, the user input unit 11 supplies only the text to the input transmission unit 12.

The input transmission unit 12 transmits the text and the seed value supplied from the user input unit 11 to the server 2.

The output reception unit 13 receives a parameter transmitted from the server 2 and supplies the parameter to the 3D model display control unit 14.

The 3D model display control unit 14 functions as a 3D model acquisition unit that executes a game engine or 3D software (e.g., Unreal Engine (registered trademark)) installed in the user terminal 1 and acquires a 3D model using the parameter supplied from the output reception unit 13. The 3D model display control unit 14 displays the acquired 3D model on the display (not illustrated) or the like.

The server 2 includes an input reception unit 31, an input analysis unit 32, a learning model storage unit 33, a parameter distribution generation unit 34, a parameter generation unit 35, and an output transmission unit 36.

The input reception unit 31 receives the text and the seed value transmitted from the user terminal 1, and supplies the text and the seed value to the input analysis unit 32. The input reception unit 31 functions as an input acquisition unit that acquires the text and the seed value input by the user.

The input analysis unit 32 analyzes the text supplied from the input reception unit 31. Specifically, the input analysis unit 32 extracts elements related to the 3D model from the text, and performs matching for associating each of the elements extracted from the text with a feature amount of the 3D model. In addition, in a case where no seed value is input in the user terminal 1, the input analysis unit 32 randomly generates a seed value. The input analysis unit 32 supplies a text analysis result and the seed value to the parameter distribution generation unit 34.

The learning model storage unit 33 stores, for example, a learning model to which the text (the elements related to the 3D model) and from which a parameter distribution for a predetermined type of feature amount, the parameter distribution including a parameter corresponding to the content of the text, is output.

The parameter distribution generation unit 34 generates a parameter distribution by acquiring a learning model that outputs a parameter distribution for a feature amount corresponding to an element related to the 3D model in the text, and inputting the element related to the 3D model to the learning model. Note that, by inputting all the elements related to the 3D model in the text to one learning model, parameter distributions for feature amounts corresponding to the respective elements related to the 3D model may be generated at once. The parameter distribution generation unit 34 supplies the seed value and the generated parameter distribution to the parameter generation unit 35.

The parameter generation unit 35 generates a parameter by sampling a parameter corresponding to the seed value from among a plurality of parameters included in the parameter distribution supplied from the parameter distribution generation unit 34. The generated parameter is a parameter indicating a value of a feature amount of a 3D model of an object to be subjected to 3D modeling, in other words, a parameter related to the object. The parameter generation unit 35 supplies the generated parameter to the output transmission unit 36.

The output transmission unit 36 transmits the parameter supplied from the parameter generation unit 35 to the user terminal 1.

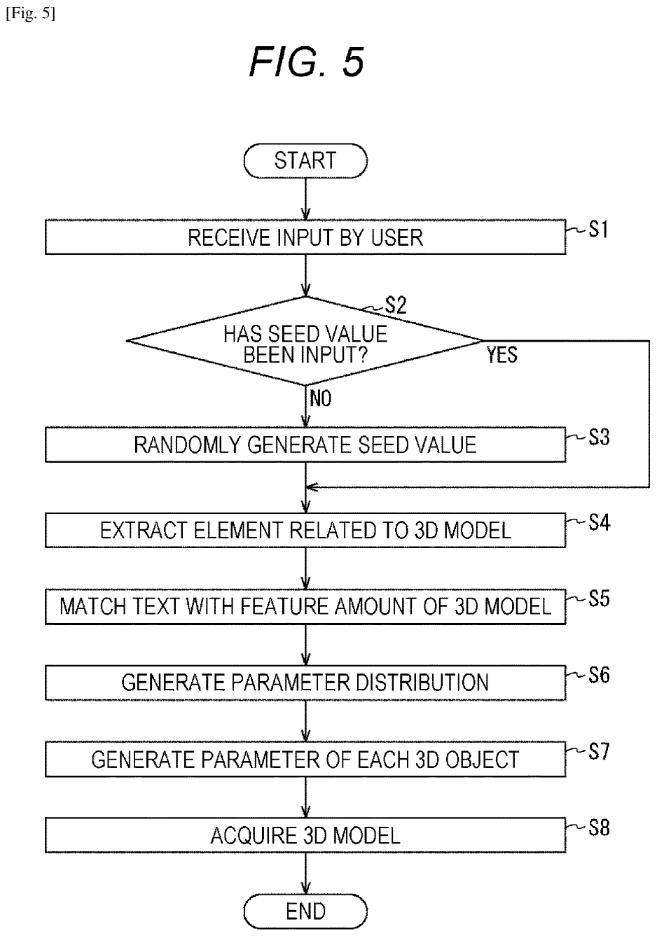

Next, processing performed by the information processing system having the above-described configuration will be described with reference to a flowchart of FIG. 5.

In step S1, the user input unit 11 of the user terminal 1 receives an input of a text and a seed value by the user. The input transmission unit 12 of the user terminal 1 transmits the text and the seed value input by the user to the server 2.

In step S2, the input analysis unit 32 of the server 2 determines whether or not a seed value has been input by the user. For example, in a case where no seed value has been transmitted from the user terminal 1, the input analysis unit 32 determines that no seed value has been input.

In a case where it is determined in step S2 that no seed value has been input, the input analysis unit 32 of the server 2 randomly generates a seed value in step S3, and the process proceeds to step S4.

On the other hand, in a case where it is determined in step S2 that a seed value has been input, the process skips step S3, and the process proceeds to step S4.

In step S4, the input analysis unit 32 of the server 2 extracts elements related to the 3D model from the text transmitted from the user terminal 1.

In step S5, the input analysis unit 32 of the server 2 matches each of the elements related to the 3D model in the text with a feature amount of the 3D model.

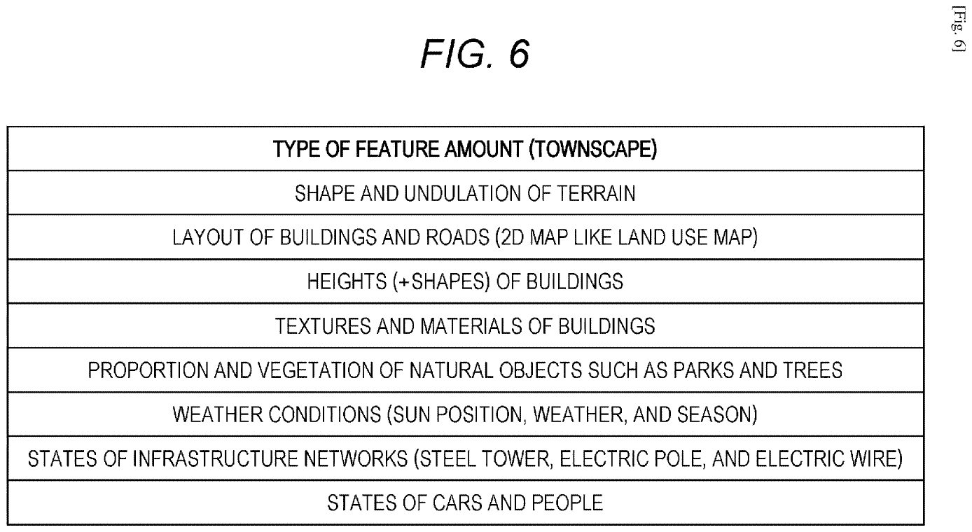

FIG. 6 is a diagram illustrating examples of the feature amounts of the 3D model. In FIG. 6, various types of feature amounts of the 3D model of the townscape are illustrated.

As illustrated in FIG. 6, examples of the feature amounts of the 3D model of the townscape include a shape and an undulation of the terrain, a layout of buildings and roads (a 2D map like a land use map), heights and shapes of buildings, textures and materials of buildings, a proportion and vegetation of natural objects such as trees and parks, weather conditions (sun position (direction), weather, season, etc.), states of infrastructure networks (steel tower, electric pole, electric wire, etc.), and states of cars and people.

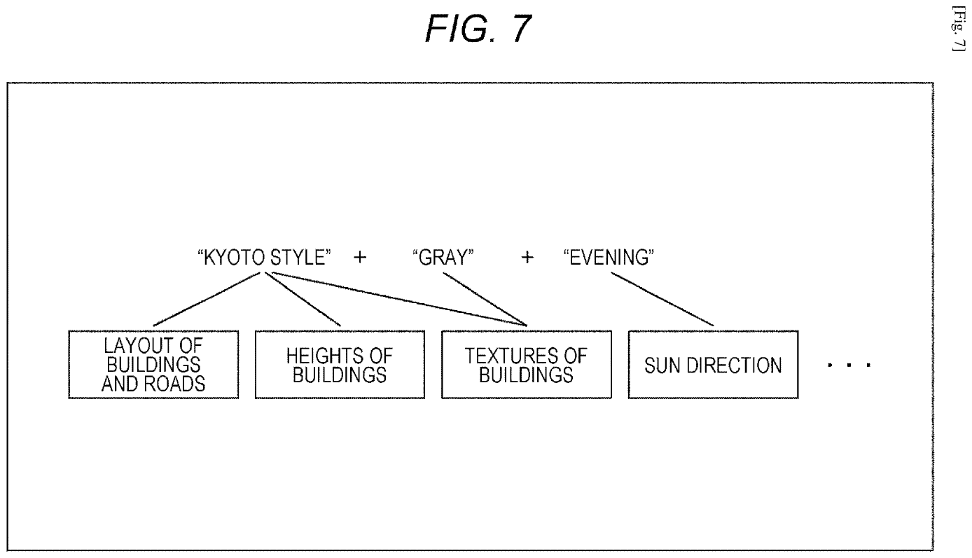

FIG. 7 is a diagram illustrating an example in which each of the elements related to the 3D model in the text is matched with a feature amount of the 3D model.

As illustrated in an upper portion of FIG. 7, it is assumed that texts “Kyoto style”, “gray”, and “evening” are extracted as elements related to the 3D model from the text input by the user.

In this case, the text “Kyoto style” is determined to be a text related to a layout of buildings and roads, heights of buildings, and textures of buildings, and is associated with these feature amounts. The text “gray” is determined to be a text related to textures of buildings, and is associated with textures of buildings. The text “evening” is determined to be a text related to a sun direction, and is associated with a sun direction.

Returning to FIG. 5, in step S6, the parameter distribution generation unit 34 of the server 2 generates a parameter distribution on the basis of a text analysis result. The analysis of the text includes extracting an element related to the 3D model from the text and matching the element with a feature amount of the 3D model.

In a case where a parameter distribution for a feature amount associated with each of the elements related to the 3D model in the text is generated, the parameter distribution generation unit 34 generates the parameter distribution by inputting each of the elements related to the 3D model in the text to the learning model that outputs the parameter distribution.

As described with reference to FIG. 7, in a case where each of the texts “Kyoto style”, “gray”, and “evening” is associated with a feature amount, a parameter distribution for a layout of buildings and roads includes, for example, a parameter in which buildings and roads are arranged in a checkerboard shape. In addition, a parameter distribution for heights of buildings includes, for example, a parameter having a value lower than a predetermined threshold. A parameter distribution for textures of buildings includes, for example, a parameter in which the textures of the buildings are of Japanese style. A parameter distribution for a sun direction includes, for example, a parameter in which the sun direction is west.

In a case where a parameter distribution for a feature amount with which an element related to the 3D model in the text is not associated is generated, the parameter distribution generation unit 34 generates a parameter distribution including an average parameter or a random parameter.

In step S7, the parameter generation unit 35 of the server 2 generates a parameter by sampling a parameter of each 3D object constituting the 3D model from among the plurality of parameters included in the parameter distribution. Here, among the plurality of parameters included in the parameter distribution, the parameter corresponding to the seed value is sampled.

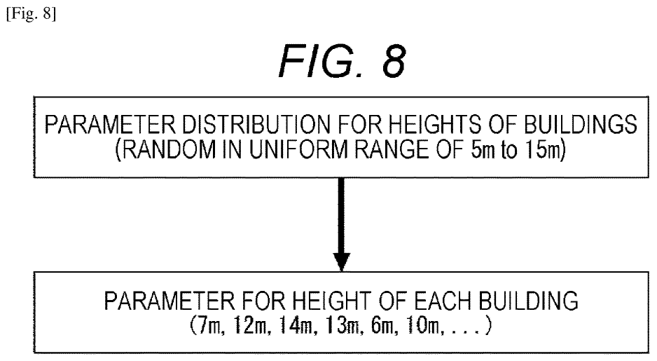

FIG. 8 is a diagram illustrating an example of a parameter sampled from the parameter distribution.

As illustrated in an upper side of FIG. 8, it is assumed that a parameter distribution for heights of buildings includes a plurality of parameters randomly selected according to a uniform distribution, for example, in a range of 5 m to 15 m.

In this case, as indicated by an arrow, the parameter generation unit 35 samples a parameter group of values of, for example, 7 m, 12 m, 14 m, 13 m, 6 m, and 10 m from the parameter distribution according to seed values as parameters for the heights of the respective buildings constituting the 3D model. Note that, in the information processing system according to the present technology, if the same seed value is input, a group of parameters having the same combination is sampled from one parameter distribution. Therefore, the same parameter is generated when the same text and the same seed value are input regardless of a timing at which the text or the seed value is input.

Returning to FIG. 5, after the parameter is generated in step S7, the output transmission unit 36 of the server 2 transmits the parameter of each 3D object to the user terminal 1.

In step S8, the 3D model display control unit 14 of the user terminal 1 acquires a 3D model using the parameter transmitted from the server 2 and displays the 3D model on the display.

As described above, the information processing system according to the present technology enables even a user who does not have knowledge or skill regarding 3D modeling to easily create a desired 3D model by inputting a text described in a natural language.

Since the parameter is sampled according to the seed value from the parameter distribution based on the input text, the information processing system according to the present technology can acquire different 3D models when the seed values are different even though the same text is input. Therefore, it is possible to ensure the diversity of 3D models to be acquired. Furthermore, in a case where the same text and the same seed value are input, the information processing system according to the present technology can sample the same parameter from the parameter distribution and acquire the same 3D model. Therefore, it is possible to ensure the reproducibility of 3D models to be acquired.

### 3. Modifications

A parameter may be acquired by sampling the parameter from the parameter distribution, and a parameter may be acquired with reference to the parameter calculated in advance.

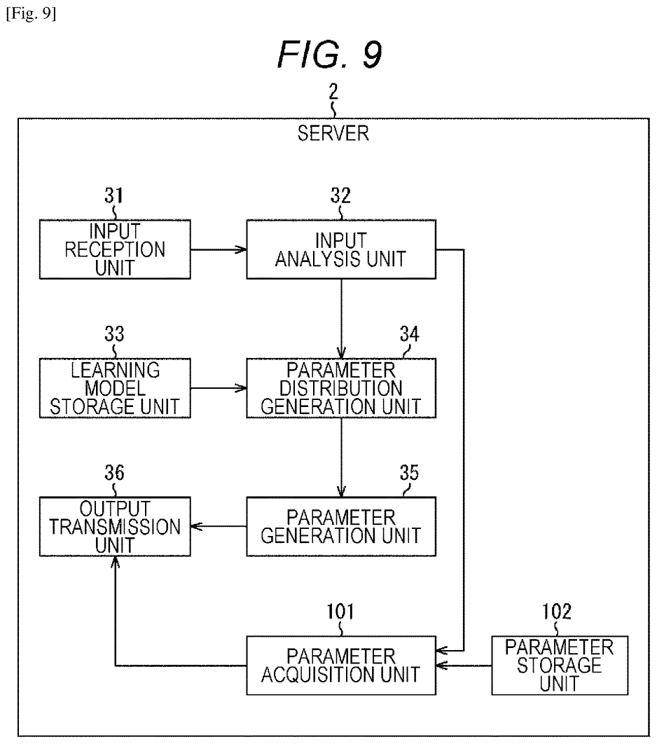

FIG. 9 is a block diagram illustrating another functional configuration example of the server 2. In FIG. 9, the same configurations as the configurations in FIG. 4 are denoted by the same reference signs. Redundant description will be omitted as appropriate.

The server 2 of FIG. 9 is different from the server 2 of FIG. 4 in that a parameter acquisition unit 101 and a parameter storage unit 102 are provided.

A text analysis result of the input analysis unit 32 is supplied to the parameter acquisition unit 101. The parameter acquisition unit 101 acquires a parameter corresponding to the content of the text, as a parameter for a feature amount corresponding to each element related to the 3D model in the text, from the parameter storage unit 102, and supplies the acquired parameter to the output transmission unit 36. The parameter acquisition unit 101 can also acquire, from the parameter storage unit 102, a parameter for a feature amount that is not associated with each element related to the 3D model in the text.

The parameter storage unit 102 stores various parameters acquired after being calculated in advance.

As described above, not all parameters are acquired by sampling the parameters from the parameter distribution, and some parameters may be acquired with reference to and from among the parameters calculated in advance.

Although the example in which 3D modeling is performed with respect to the townscape has been described above, the information processing system according to the present technology can set a 3D modeling target to an environment including a townscape, a building, a natural terrain, or the like, or a movable object, which is a moving object including a person (e.g., a whole body or a face), an animal, a vehicle, a flying object, a ship, or the like. In the information processing system according to the present technology, feature amounts (parameters) necessary for 3D-modeling an environment, a movable object, or the like to be subjected to 3D modeling are assumed in advance, and a setting is performed such that a parameter for a corresponding feature amount is generated.

Note that it is also possible for the user to input a text specifying a 3D modeling target together with a text indicating a state of the 3D modeling target. In this case, a target of 3D modeling to be performed by the information processing system is determined on the basis of the text input by the user. As described above, the text indicating a 3D modeling target includes a text indicating a state of the 3D modeling target together with a text specifying the 3D modeling target.

In one aspect, generative artificial intelligence (AI) can be used to generate the 3D model based on the input text. Generative AI is artificial intelligence capable of creating new content using generative models based on the data they were trained with. For example, the learning model described herein can be a generative AI model. Creating a 3D model from text input using generative AI involves a combination of natural language processing (NLP) and 3D modeling techniques.

Generally speaking, generative AI can be harnessed to create 3D models from text input through a multi-step process. Firstly, textual descriptions of the desired 3D object are gathered or generated. These descriptions should encompass comprehensive details regarding the object's dimensions, shape, texture, color, and other relevant features. Once this textual data is collected, it is tokenized and encoded to make it comprehensible to the AI model. The next step involves selecting or creating a suitable generative AI model with text-to-3D generation capabilities. This AI model takes the encoded text descriptions as input and, using its underlying architecture, generates a corresponding 3D representation.

This representation could take the form of a point cloud, a mesh, or a voxel model. The output is the AI's interpretation of the 3D object described in the text. Following the AI's output, post-processing helps align the AI-generated model with the original concept or project requirements. By iterating through this process and refining the AI model or text inputs, the generated 3D model can be optimized until it meets the desired specifications. An exemplary embodiment can be summarized as follows:
1. Collect or Generate Text Descriptions: collecting or generating text descriptions of the 3D object to be modeled. These descriptions can be detailed and include information about the object's shape, size, texture, color, and any other relevant features, for example.
2. Choose a Generative AI Model: selecting a generative AI model capable of understanding and translating text into 3D shapes (e.g., DALL-E).

3. Data Preprocessing: Tokenization: The text descriptions are tokenized into a format that the AI model can understand. Text Encoding: The tokenized text is converted into a numerical format that the AI model can work with.
4. Training or Fine-Tuning (if required): fine-tuning the model on a dataset containing pairs of text descriptions and corresponding 3D models. This step can help the AI model better understand the relationship between text and 3D shapes.
5. Generate 3D Models: Input Text: Feed the tokenized and encoded text description into the generative AI model. Text-to-3D Generation: The AI model generates a 3D representation based on the input text. The generated 3D model may be in a format like a point cloud, mesh, or voxel representation, for example.
6. Post-Processing: Convert to Usable 3D Format: Depending on the output format of the AI model, the generated 3D model may need to be converted into a more standard 3D file format like .OBJ, .STL, or .FBX. Refinement: The generated 3D model might require post-processing to enhance its quality and details.
7. Visualization and Modification: Visualize: Open the 3D model in 3D modeling software or a 3D viewer to inspect and evaluate it. Modify: Make any necessary modifications to the 3D model to match the original concept or requirements.
8. Iterate and Optimize: Iterate through the process, adjusting the text descriptions, retraining the AI model if needed, and refining the 3D model until the desired results are achieved.

Accordingly, using the generative AI model as the learning model can associate the elements of the input text related to the target model with features of the 3D model. The generative AI model could also include the step of determining the parameter distribution by selecting multiple features of the 3D model and sampling the parameter corresponding to the seed value.

Some of the functions of the user terminal 1 may be provided in the server 2, or all or some of the functions of the server 2 may be provided in the user terminal 1. For example, the server 2 can acquire a 3D model using a generated parameter, and the user terminal 1 can generate a parameter distribution and a parameter.

### Concerning Computer

The series of processes described above can be executed by hardware or by software. In a case where the series of processes is executed by software, a program constituting the software is installed from a program recording medium to a computer incorporated in dedicated hardware, a general-purpose personal computer, or the like.

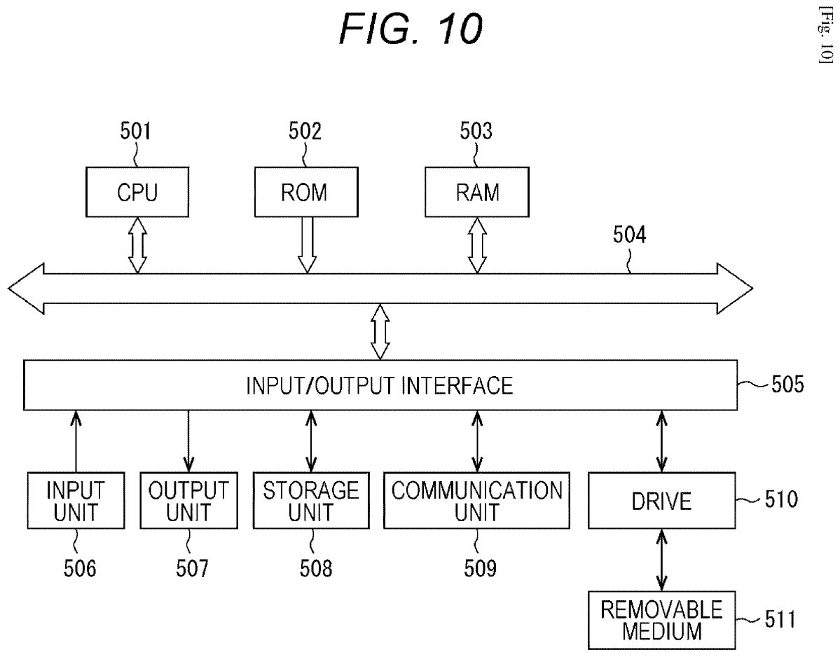

FIG. 10 is a block diagram illustrating a configuration example of the hardware of the computer that executes the above-described series of processes by the program.

A central processing unit (CPU) 501, a read only memory (ROM) 502, and a random access memory (RAM) 503 are connected to each other by a bus 504.

An input/output interface 505 is further connected to the bus 504. An input unit 506 including a keyboard, a mouse, and the like, and an output unit 507 including a display, a speaker, and the like are connected to the input/output interface 505. Furthermore, a storage unit 508 including a hard disk, a nonvolatile memory, and the like, a communication unit 509 including a network interface and the like, and a drive 510 that drives a removable medium 511 are connected to the input/output interface 505.

In the computer configured as described above, for example, the CPU 501 loads a program stored in the storage unit 508 into the RAM 503 via the input/output interface 505 and the bus 504 and executes the program to perform the above-described series of processes.

For example, the program to be executed by the CPU 501 is stored in the removable medium 511, or provided via a wired or wireless transmission medium such as a local area network, the Internet, or digital broadcasting, and then installed in the storage unit 508.

The program to be executed by the computer may be a program in which the processes are performed in time series in the order described in the present specification, or may be a program in which the processes are performed in parallel or at a necessary timing, for example, when a call is made.

Note that in the present specification, a system means a set of a plurality of components (devices, modules (parts), and the like), and it does not matter whether or not all the components are in the same housing. Therefore, a plurality of devices housed in separate housings and connected to each other via a network and one device in which a plurality of modules is housed in one housing are both systems.

The effects described in the present specification are merely examples and are not limited, and other effects may be provided.

Embodiments of the present technology are not limited to the above-described embodiments, and various modifications can be made without departing from the gist of the present technology.

For example, the present technology can have a cloud computing configuration in which one function is shared and processed in cooperation by a plurality of devices via a network.

Furthermore, each of the steps described in the above-described flowchart can be executed by one device or executed by a plurality of devices in a shared manner.

Moreover, in a case where a plurality of processes is included in one step, the plurality of processes included in one step can be executed by one device, or executed by a plurality of devices in a shared manner.

### Combination Examples of Configurations

The present technology can have the following configurations.

(1)

A system, comprising:

processing circuitry configured to

acquire text indicating a target model,

generate a parameter based on the text, and

acquire a three-dimensional (3D) model of the target model based on the parameter.

(2)

The system according to (1), wherein the processing circuitry is further configured to extract one or more elements related to the target model from the text.

(3)

The system according to (1) or (2), wherein the processing circuitry is further configured to

match each of the one or more elements related to the target model with one or more 3D model features.

(4)

The system according to any one of (1) to (3), wherein the processing circuitry for acquiring the text indicating the target model is further configured to

receive the text entered at a text input screen on a display.

(5)

The system according to any one of (1) to (4), wherein the processing circuitry for acquiring the text indicating the target model is further configured to

receive the text entered at a text input screen through a voice of a user.

(6)

The system according to any one of (1) to (5), wherein the processing circuitry is further configured to

acquire a seed value.

(7)

The system according to any one of (1) to (6), wherein the processing circuitry is further configured to

in response to a determination that no seed value is acquired, randomly generate the seed value.

(8)

The system according to any one of (1) to (7), wherein the processing circuitry is further configured to

use the acquired seed value together with the text to generate the parameter.

(9)

The system according to any one of (1) to (8), wherein the processing circuitry is further configured to

generate a parameter distribution based on an element of the text related to the target model, wherein the parameter distribution includes a plurality of parameters randomly selected according to a uniform distribution within a range in which a feature of the 3D model corresponds to the element of the text.

(10)

The system according to any one of (1) to (9), wherein the 3D model of the target model is acquired by selecting the 3D model generated using the parameter from among a plurality of 3D models generated in advance.

(11)

The system according to any one of (1) to (10), wherein the processing circuitry for generating the parameter based on the seed value and the text is further configured to sample the parameter corresponding to the seed value from among a plurality of parameters included in a parameter distribution, wherein the plurality of parameters are randomly selected for the parameter distribution according to a uniform distribution within a range in which the 3D model corresponds to the text.

(12)

The system according to any one of (1) to (11), wherein the generated parameter indicates a value of a feature of the one or more 3D model features.

(13)

The system according to any one of (1) to (12), wherein the generated parameter is acquired from a memory in a case where an element in the text related to a feature of the one or more 3D model features exists in the memory.

(14)

The system according to any one of (1) to (13), wherein the parameter is generated based on the text by a generative artificial intelligence (AI) model.
(15)

The system according to any one of (1) to (14), wherein the processing circuitry for generating the parameter based on the text is further configured to

generate a parameter distribution based on a learning model, wherein the parameter distribution includes a plurality of parameters randomly selected according to a uniform distribution within a range in which the 3D model corresponds to the text.

(16)

The system according to any one of (1) to (15),

wherein the learning model is a generative artificial intelligence (AI) model.

(17)

The system according to any one of (1) to (16), comprising a user terminal and a server, wherein

the server is configured to acquire the text indicating the target model and generate the parameter based on the text, and

the user terminal is configured to acquire the 3D model of the target model based on the parameter.

(18)

The system according to any one of (1) to (17), comprising one device configured to:

acquire the text indicating the target model;

generate the parameter based on the text; and

acquire the 3D model of the target model based on the parameter.

(19)

The system according to any one of (1) to (18), wherein the processing circuitry is further configured to

generate a parameter distribution based on all elements of the text related to the target model, wherein the parameter distribution includes a plurality of parameters randomly selected according to a uniform distribution within a range in which the 3D model corresponds to the text.

(20)

The system according to any one of (1) to (19), wherein the memory stores various parameters acquired after being calculated in advance.

(21)

The system according to any one of (1) to (20), wherein the processing circuitry is further configured to

input, into the learning model, an element in the text related to the target model, and output, from the learning model, the parameter distribution for a feature of the 3D model related to the element in the text.

(22)

The system according to any one of (1) to (21), wherein the processing circuitry is further configured to

in a case in which a parameter distribution is generated for a feature of the 3D model with which an element of the text related to the target model is not associated, generate a parameter distribution including an average parameter or a random parameter.

(23)

A non-transitory computer-readable storage medium storing computer-readable instructions thereon which, when executed by an information processing device, cause the information processing device to perform a method, the method comprising:

acquiring text indicating a target model;

generating a parameter based on the text; and

acquiring a three-dimensional (3D) model of the target model based on the parameter.

(24)

A method, comprising:

acquiring text indicating a target model;

generating a parameter based on the text; and

acquiring a three-dimensional (3D) model of the target model based on the parameter.

In addition, the present technology can also have the following configurations.

(1)

An information processing method including:

acquiring a text input by a user and indicating a modeling target;

generating a first parameter based on the text; and

acquiring a 3D model of the modeling target using the first parameter.

(2)

The information processing method according to (1), further including generating a parameter distribution including the first parameter on the basis of the text,

in which the first parameter is generated by sampling the first parameter from the parameter distribution.

(3)

The information processing method according to (2), further including acquiring a seed value for sampling the first parameter from the parameter distribution,

in which the 3D model of the modeling target is acquired using the first parameter sampled according to the seed value.

(4)

The information processing method according to (3), in which the seed value is input by the user.

(5)

The information processing method according to (4), in which in a case where the seed value is not input by the user, the seed value is randomly generated.

(6)

The information processing method according to (2), in which the parameter distribution is generated using a learning model to which the text is input and from which the parameter distribution is output.

(7)

The information processing method according to any one of (1) to (6), in which the first parameter relates to at least one of an environment and a movable object as the modeling target.

(8)

The information processing method according to any one of (1) to (7), in which the text is input using at least one of a character and a voice.

(9)

The information processing method according to any one of (1) to (8), further including analyzing the text,

in which the first parameter is generated on the basis of a result of analyzing the text.

(10)

The information processing method according to (9), in which the text is analyzed by extracting an element related to the 3D model of the modeling target from the text, and matching the element with a feature amount of the 3D model of the modeling target.

(11)

The information processing method according to any one of (1) to (10), in which the 3D model of the modeling target is acquired by generating the 3D model of the modeling target using the first parameter.

(12)

The information processing method according to any one of (1) to (10), in which the 3D model of the modeling target is acquired by selecting the 3D model of the modeling target generated using the first parameter from among a plurality of 3D models generated in advance.

(13)

The information processing method according to any one of (1) to (12), in which the 3D model of the modeling target is acquired using a second parameter calculated in advance together with the first parameter.

(14)

The information processing method according to any one of (1) to (13), in which the text includes a first text indicating a state of the modeling target.

(15)

The information processing method according to any one of (1) to (14), in which the text includes a second text specifying the modeling target.

(16)

An information processing device including:

an input acquisition unit that acquires a text indicating a modeling target input by a user;

a generation unit that generates a parameter based on the text; and

a 3D model acquisition unit that acquires a 3D model of the modeling target using the parameter.

(17)

An information processing system including:

a terminal; and

a server device,

in which the terminal includes an input unit that receives an input of a text indicating a modeling target by a user, and a 3D model acquisition unit that acquires a 3D model of the modeling target using a parameter based on the text, and

the server device includes a generation unit that generates the parameter based on the text input in the terminal.

It should be understood by those skilled in the art that various modifications, combinations, sub-combinations and alterations may occur depending on design requirements and other factors insofar as they are within the scope of the appended claims or the equivalents thereof.

### Reference Signs List

1 User terminal
2 Server
11 User input unit
12 Input transmission unit
13 Output reception unit
14 3D model display control unit
31 Input reception unit
32 Input analysis unit
33 Learning model storage unit
34 Parameter distribution generation unit
35 Parameter generation unit
36 Output transmission unit
101 Parameter acquisition unit
102 Parameter storage unit

1. A system, comprising:
processing circuitry configured to
acquire text indicating a target model,
generate a parameter based on the text, and
acquire a three-dimensional (3D) model of the target model based on the parameter.

2. The system of claim 1, wherein the processing circuitry is further configured to
extract one or more elements related to the target model from the text.

3. The system of claim 2, wherein the processing circuitry is further configured to
match each of the one or more elements related to the target model with one or more 3D model features.

4. The system of claim 1, wherein the processing circuitry for acquiring the text indicating the target model is further configured to
receive the text entered at a text input screen on a display.

5. The system of claim 1, wherein the processing circuitry for acquiring the text indicating the target model is further configured to
receive the text entered at a text input screen through a voice of a user.

6. The system of claim 3, wherein the processing circuitry is further configured to
acquire a seed value.

7. The system of claim 6, wherein the processing circuitry is further configured to
in response to a determination that no seed value is acquired, randomly generate the seed value.

8. The system of claim 6, wherein the processing circuitry is further configured to
use the acquired seed value together with the text to generate the parameter.

9. The system of claim 1, wherein the processing circuitry is further configured to
generate a parameter distribution based on an element of the text related to the target model, wherein the parameter distribution includes a plurality of parameters randomly selected according to a uniform distribution within a range in which a feature of the 3D model corresponds to the element of the text.

10. The system of claim 1, wherein the 3D model of the target model is acquired by selecting the 3D model generated using the parameter from among a plurality of 3D models generated in advance.

11. The system of claim 8, wherein the processing circuitry for generating the parameter based on the seed value and the text is further configured to
sample the parameter corresponding to the seed value from among a plurality of parameters included in a parameter distribution, wherein the plurality of parameters are randomly selected for the parameter distribution according to a uniform distribution within a range in which the 3D model corresponds to the text.

12. The system of claim 11, wherein the generated parameter indicates a value of a feature of the one or more 3D model features.

13. The system of claim 3, wherein the generated parameter is acquired from a memory in a case where an element in the text related to a feature of the one or more 3D model features exists in the memory.

14. The system of claim 1, wherein the parameter is generated based on the text by a generative artificial intelligence (AI) model.

15. The system of claim 1, wherein the processing circuitry for generating the parameter based on the text is further configured to
generate a parameter distribution based on a learning model, wherein the parameter distribution includes a plurality of parameters randomly selected according to a uniform distribution within a range in which the 3D model corresponds to the text.

16. The system of claim 15, wherein the learning model is a generative artificial intelligence (AI) model.

17. The system of claim 1, comprising a user terminal and a server, wherein
the server is configured to acquire the text indicating the target model and generate the parameter based on the text, and
the user terminal is configured to acquire the 3D model of the target model based on the parameter.

18. The system of claim 1, comprising one device configured to:
acquire the text indicating the target model;
generate the parameter based on the text; and
acquire the 3D model of the target model based on the parameter.

19. A non-transitory computer-readable storage medium storing computer-readable instructions thereon which, when executed by an information processing device, cause the information processing device to perform a method, the method comprising:
acquiring text indicating a target model;
generating a parameter based on the text; and
acquiring a three-dimensional (3D) model of the target model based on the parameter.

20. A method, comprising:
acquiring text indicating a target model;
generating a parameter based on the text; and
acquiring a three-dimensional (3D) model of the target model based on the parameter.
